(19) United States
(12) Patent Application Publication
(10) Pub. No.: US 2014/0157115 A1
(43) Pub. Date: Jun. 5, 2014

(54) IMAGE PROCESSING APPARATUS CAPABLE OF DISPLAYING PREVIEW IMAGE, METHOD OF DISPLAYING PREVIEW IMAGE, AND STORAGE MEDIUM

(71) Applicant: CANON KABUSHIKI KAISHA, Tokyo (JP)

(72) Inventor: Yuushi SATO, Kawasaki-shi (JP)

(73) Assignee: CANON KABUSHIKI KAISHA, Tokyo (JP)

(21) Appl. No.: 14/095,290

(22) Filed: Dec. 3, 2013

(30) Foreign Application Priority Data
Dec. 4, 2012 (JP) 2012-265172

(51) Int. Cl. G06F 17/21

(52) U.S. Cl. CPC G06F 17/212; G06F 17/217
USPC 715/251

(57) ABSTRACT

A image display technique which is improved in user-friendliness by reducing time required to display a preview image even in a case where image data with bookbinding print settings is displayed as a preview in the order of physical pages. Bookbinding image data is generated by executing bookbinding layout processing on input image data. Either normal page numbers or bookbinding page numbers are assigned to respective pages of the bookbinding-laid-out image data. A preview image of the bookbinding image data is generated based on the assigned page numbers and displayed on a display panel. A preview image of at least a page next to a page of which the preview image is being displayed is generated based on the assigned page numbers during display of the preview image on the display panel.

### BACKGROUND OF THE INVENTION

1. Field of the Invention

The present invention relates to an image processing apparatus, a method of displaying a preview image, and a storage medium, and more particularly to an image processing apparatus that is capable of displaying a preview of image data to be printed as a booklet, a method of displaying a preview image, and a storage medium.

2. Description of the Related Art

Conventionally, a print preview function provided by an application program is not configured to be capable of displaying, as a preview image, an image on which various print conditions which can be set by a printer driver are reflected. For this reason, a print layout in a preview image may differ from an actual print layout, which means that the print preview is useless. To solve this problem, there has been disclosed a technique that makes it possible to display a preview image on which the print layout is accurately reflected, more particularly, a preview image on which the print layout after being subjected to bookbinding is reflected (see Japanese Patent Laid-Open Publication No. 2001-136364).

Further, in a case where images for a plurality of pages are displayed as a preview, it is possible to reduce memory consumption of the apparatus to the minimum by using a method of generating a preview image of only images required to be displayed. However, it takes a lot of time to generate the preview image, which increases a waiting time for the preview display. On the other hand, there has been proposed a method of generating thumbnails or preview images from all stored images in advance, and recording the generated images in a storage medium (see Japanese Patent Laid-Open Publication No. H11-53520), but this method necessitates a large storage area to store these images, and hence it is required to increase the capacity of a storage device, such as a hard disk.

To solve the above-mentioned problem, there has been disclosed a technique that makes it possible to reduce the waiting time for the preview image display by preparing minimum necessary preview images in advance to thereby display thumbnails or preview images at high speed without occupying a large storage area of the storage device, such as a hard disk (see Japanese Patent Laid-Open Publication No. 2006-203702).

However, in the above-mentioned conventional technique, for example, in a case where physical pages on which images for a plurality of pages are laid out are to be displayed in the order of the physical pages, there is a possibility that a preview image to be displayed next cannot be prepared in advance, and it is impossible to switch display between preview images at high speed.

### SUMMARY OF THE INVENTION

The present invention provides an image display technique which is improved in user-friendliness by reducing time required to display a preview image even in a case where image data with bookbinding print settings is displayed as a preview in the order of physical pages.

In a first aspect of the present invention, there is provided an image processing apparatus comprising a bookbinding image data generation unit configured to generate bookbinding image data by executing bookbinding layout processing on input image data, a management unit configured to assign page numbers to respective pages of the bookbinding image data generated by said bookbinding image data generation unit, a preview image generation unit configured to generate a preview image of the bookbinding image data based on the page numbers assigned by said management unit, and

a display unit configured to display the preview image of the bookbinding image data, wherein said preview image generation unit generates a preview image of at least a page next to a page of which the preview image is being displayed, based on the page numbers assigned by said management unit during display of the preview image on said display unit.

In a second aspect of the present invention, there is provided a method of displaying a preview image by an image processing apparatus including a display unit that displays an image, comprising generating bookbinding image data by executing bookbinding layout processing on input image data, assigning page numbers to respective pages of the generated bookbinding image data, generating a preview image of the bookbinding image data based on the assigned page numbers, and displaying the preview image of the bookbinding image data on the display unit, wherein said generating of the preview image of bookbinding image data includes generating a preview image of at least a page next to a page of which the preview image is being displayed, based on the assigned page numbers during display of the preview image on the display unit.

In a third aspect of the present invention, there is provided a non-transitory computer-readable storage medium storing a computer-executable program for causing a computer to execute a method of displaying a preview image by an image processing apparatus including a display unit that displays an image, wherein the method comprises generating bookbinding image data by executing bookbinding layout processing on input image data, assigning page numbers to respective pages of the generated bookbinding image data, generating a preview image of the bookbinding image data based on the assigned page numbers, and displaying the preview image of the bookbinding image data on the display unit, wherein said generating of the preview image of bookbinding image data includes generating a preview image of at least a page next to a page of which the preview image is being displayed, based on the assigned page numbers during display of the preview image on the display unit.

According to the present invention, even in the case where image data with bookbinding print settings is displayed as a preview in the order of physical pages, it is possible to improve user-friendliness by reducing time required to display the preview image.

Further features of the present invention will become apparent from the following description of exemplary embodiments with reference to the attached drawings.

### BRIEF DESCRIPTION OF THE DRAWINGS

FIG. 1 is a diagram of an image processing system including an image processing apparatus according to a first embodiment of the present invention.

FIG. 2 is a schematic block diagram of the hardware configuration of an MFP appearing in FIG. 1.

FIG. 3 is a schematic block diagram showing the software configuration operating on a CPU appearing in FIG. 2.

FIG. 4 is a diagram showing an example of a bookbinding page preview screen displayed on a display panel of a console section.

FIG. 5 is a flowchart of a preview image display process executed by the image processing apparatus according to the first embodiment.

FIG. 6 is a flowchart of a preview image display process executed by an image processing apparatus according to a second embodiment of the present invention.

FIG. 7 is a flowchart of a next page preview image generation process, executed in steps in FIG. 6.

FIG. 8 is a flowchart of a preview image display process executed by an image processing apparatus according to a third embodiment of the present invention.

### DESCRIPTION OF THE EMBODIMENTS

The present invention will now be described in detail below with reference to the accompanying drawings showing embodiments thereof.

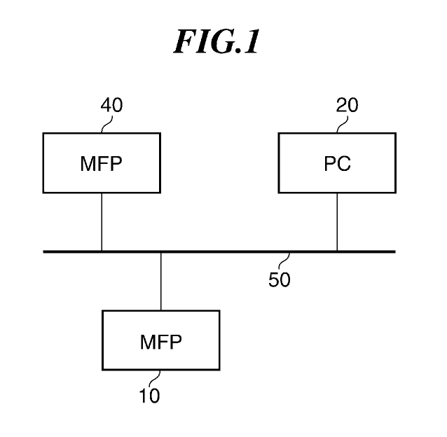

FIG. 1 is a diagram of an image processing system including an image processing apparatus according to a first embodiment of the present invention.

Referring to FIG. 1, the image processing system includes MFPs 10 and 40, each of which is an example of the image processing apparatus, a PC 20 which is an example of an information processing apparatus, and a LAN 50 which connects these apparatuses to each other.

The MFPs 10 and 40 are multi-function peripherals equipped with a copy function, a print function, a data transmission function, and so forth. The PC 20 is a personal computer equipped with a function of receiving an operation input from a user e.g. via a mouse, a keyboard, or a tablet, and generating image data based on the received operation. The PC 20 also has a function of transmitting the generated image data to the MFPs 10 and 40.

The MFPs 10 and 40 each store the image data received from the PC 20 in a memory thereof, and are capable of printing the image data stored in the memory according to an instruction from the user.

Although in the present embodiment, the MFP will be described as an example of the image processing apparatus, this is not limitative, but the image processing apparatus may be in any other form, such as an SFP (single function printer) and a PC, insofar as it is capable of displaying image data.

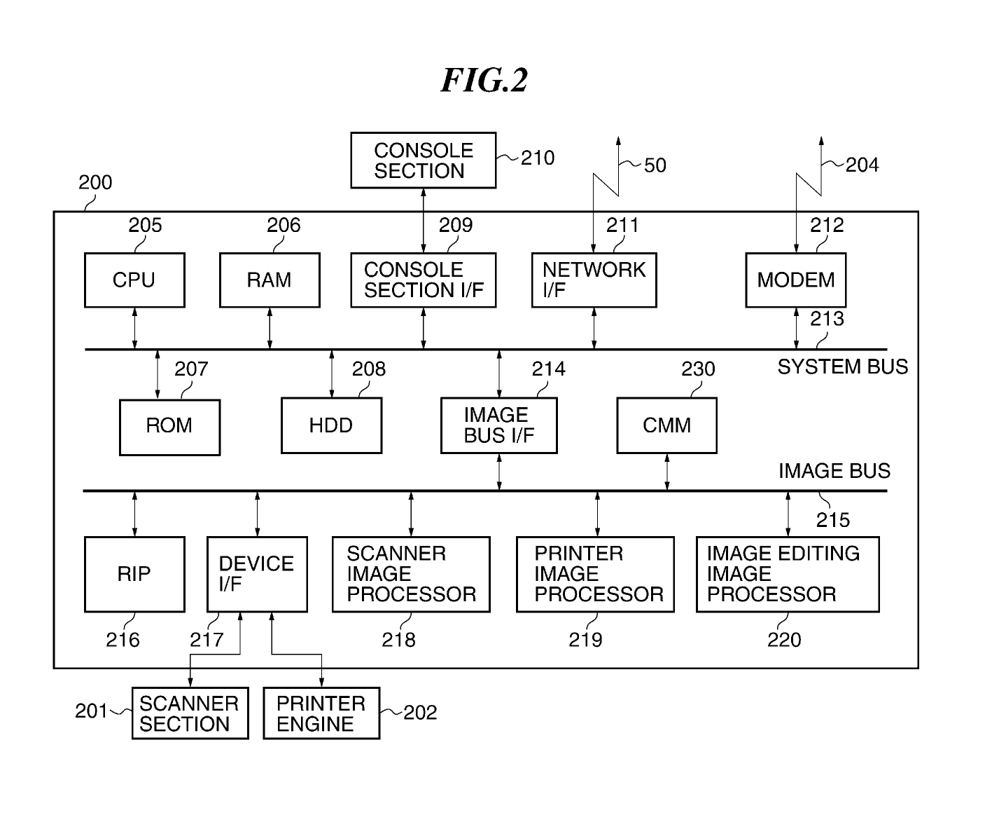

Next, the internal configuration of the MFP 10 will be described with reference to FIG. 2. Note that the MFP 40 has the same configuration as the MFP 10, and description thereof is omitted.

FIG. 2 is a schematic block diagram of the hardware configuration of the MFP 10 appearing in FIG. 1.

Referring to FIG. 2, the MFP 10 includes a control unit 200, a console section 210, a scanner section 201, and a printer engine 202.

The control unit 200 is connected to the scanner section 201 which is an image input device, and the printer engine 202 which is an image output device, and performs control for reading of image data by the scanner section 201 and printing of image data by the printer engine 202. Further, the control unit 200 is connected to the LAN 50 and a public communication line 204, and controls the flows of image data and device information input and output via these lines.

A CPU 205 is a central processing unit for controlling the overall operation of the MFP 10. A RAM 206 is a system work memory used for operation of the CPU 205, and also functions as an image memory for temporarily storing input image data. A ROM 207 is a boot ROM that stores a boot program of the system. An HDD 208 is a hard disk drive for storing system software for various kinds of processing, input image data, and so forth.

The console section 210 has a display panel of a touch-panel type, which can receive an operation input from the user and display an image data and the like. A console section interface 209 interfaces with the console section 210, and outputs image data to the console section 210. Further, the console section interface 209 also has a function of transmitting information input by the user via the console section 210 to the CPU 205.

A network interface 211 is an interface connected to the LAN 50 for performing communication, and inputs and outputs information from and to external apparatuses including the PC 20. A modem 212 is an interface connected to the public communication line 204 for performing communication, and inputs and outputs information from and to external apparatuses including the MFP 40.

The above-mentioned units are connected to a system bus 213.

An image bus interface 214 is an interface for connection between the system bus 213 and an image bus 215 that transfers image data at high speed, and is a bus bridge that performs conversion of data format. Connected to the image bus 215 are a raster image processor (RIP) 216, a device interface 217, a scanner image processor 218, a printer image processor 219, an image editing image processor 220, and a color management module (CMM) 230.

The RIP 216 rasterizes a page description language (PDL) code or vector data, described hereinafter, into bitmap image data. The device interface 217 is an interface connected to the scanner section 201 and the printer engine 202, for performing synchronous-to-asynchronous or asynchronous-to-synchronous conversion of image data.

The scanner image processor 218 performs various kinds of processing, such as correction, manipulation, and editing, of image data input from the scanner section 201. The printer image processor 219 performs correction, resolution conversion, etc. of image data to be printed out, in accordance with the performance of the printer engine 202. The image editing image processor 220 performs various kinds of image processing, such as rotation and compression/expansion of image data.

The CMM 230 is a dedicated hardware module for performing color conversion (also referred to as “color space conversion”) on image data based on a profile or calibration data. The profile is information including information on functions for converting color image data expressed by a device-dependent color space to a device-independent color space (e.g. Lab). Further, the calibration data is for correcting color reproduction characteristics of the scanner section and the printer engine of a color multifunction peripheral (MFP).

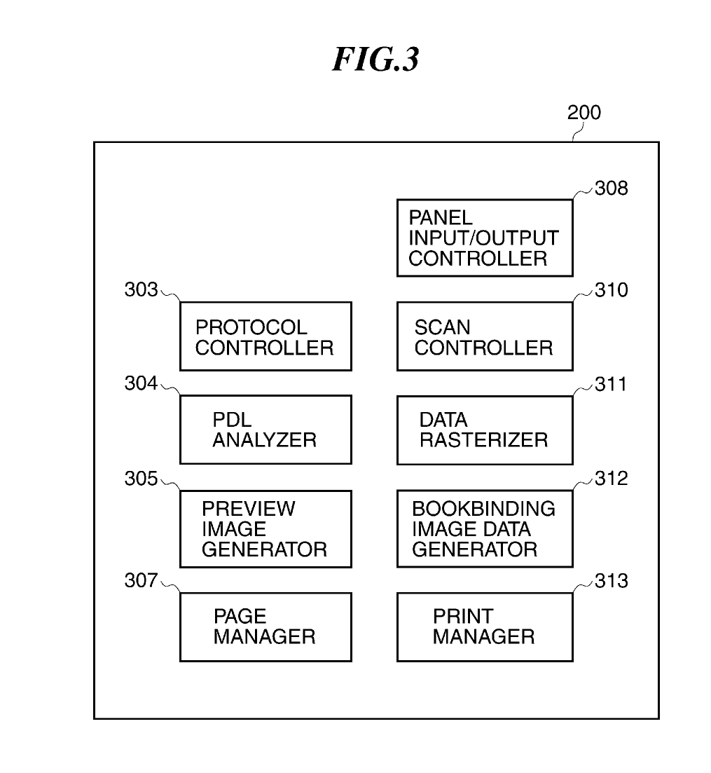

Next, the software configuration of the MFP 10 will be described with reference to FIG. 3.

FIG. 3 is a schematic block diagram showing the configuration of software operating on the CPU 205 appearing in FIG. 2.

A protocol controller 303 is a component that controls communication with an external apparatus by analyzing a network protocol and controlling transmission and reception of data.

A PDL analyzer 304 is a component that analyzes a PDL code and converts the PDL code to an intermediate code (display list) having a format that can be processed more easily. When generating a preview image, the intermediate code generated by the PDL analyzer 304 is passed to a preview image generator 305 and is processed thereby.

The preview image generator 305 rasterizes the intermediate code received from the PDL analyzer 304 into bitmap data, and sequentially stores the bitmap data in a page memory (not shown) as preview image data. The page memory is allocated to a volatile memory, such as the RAM 206, and temporarily stores bitmap data rasterized by the preview image generator 305 and a data rasterizer 311.

A page manager 307 manages page numbers when a preview image is displayed. The page manager 307 assigns normal page numbers or bookbinding page numbers to respective pages of image data (bookbinding image data) subjected to bookbinding layout processing for laying out image data for bookbinding, and controls the order of preview display based on either the normal page numbers or the bookbinding page numbers. A panel input/output controller 308 is a component that controls an operation input and a display output to and from the operation panel of the console section 210.

A scan controller 310 is a component that performs various kinds of processing, such as correction, manipulation, and editing, of image data input from the scanner section 201.

The data rasterizer 311 is a component that rasterizes an intermediate code into bitmap data. The rasterized bitmap data is sequentially stored in the page memory.

A bookbinding image data generator 312 performs bookbinding image data processing, including processing for double-sided printing, processing for aggregate printing, and bookbinding layout, on image data stored in the HDD 208. A print manager 313 converts image data stored in the page memory to a video signal, and transfers the video signal to the printer engine 202.

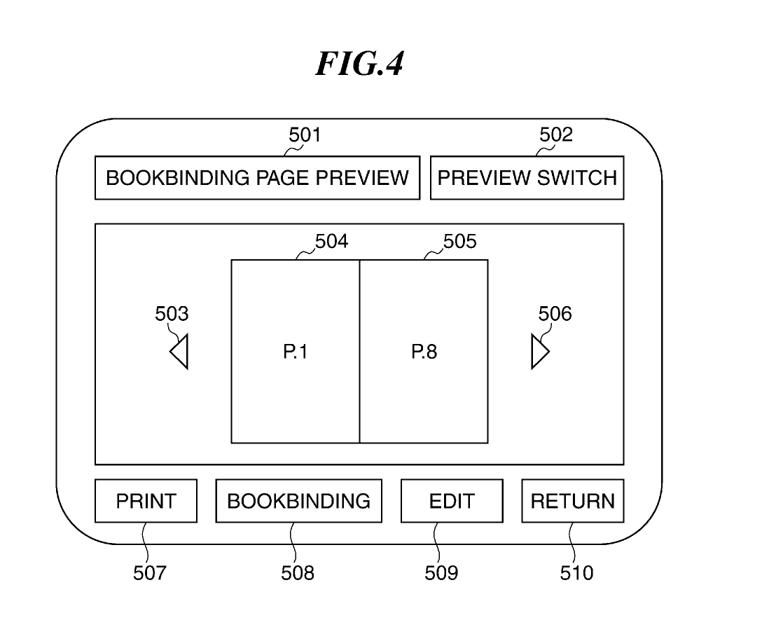

Next, the display panel of the console section 210, on which a preview image is displayed, will be described with reference to FIG. 4.

FIG. 4 is a diagram showing an example of a bookbinding page preview screen displayed on the display panel of the console section 210. Note that the form and design of a display on the display panel are not limited to the illustrated example.

Referring to FIG. 4, a screen name display section 501 is a display section for identifying whether a screen displayed on the console section 201 is a bookbinding page preview screen or a normal page preview screen. In the illustrated example, the screen name display section 501 indicates that the bookbinding page preview screen is displayed. A preview switch button 502 (display switching unit) is used for switching the preview between the bookbinding page preview screen (first display method) and the normal page preview screen (second display method).

A preceding page button 503 is used for changing a page image being displayed to the preceding page image. A next page button 506 is used for changing the page image being displayed to the next page image. If there is no preceding page before the page image being displayed, the preceding page button 503 is grayed out. Further, if there is no next page after the page image being displayed, the next page button 506 is grayed out.

Preview image-displaying sections 504 and 505 are display sections on each of which a preview image of each page of image data to be printed as a booklet is displayed.

A print button 507 is used by the user for instructing the MFP 10 to execute printing. A bookbinding button 508 is used by the user for instructing the MFP 10 to shift to a screen for changing bookbinding print settings. An edit button 509 is used by the user for instructing the MFP 10 to shift to a screen for editing image data.

A return button 510 is used for canceling the preview display and returning to a menu screen (not shown).

When the user selects the bookbinding page preview screen, image data subjected to bookbinding layout is displayed on the preview image-displaying sections 504 and 505 as the preview in the order of physical pages (in an actual printing order). For example, when image data of eight pages is set to bookbinding printing with the settings of double-sided printing, saddle-stitching, and folding in two, physical pages to be printed are in an order of first and eighth pages, second and seventh pages, sixth and third pages, and fourth and fifth pages. Then, the MFP 10 generates a preview image of the first page and then a preview image of the eighth page, and displays the generated preview images on the preview image-displaying sections 504 and 505, respectively (see the illustrated example). Further, the MFP 10 generates preview images of the second and seventh pages, and stores the generated preview images in the page memory as rasterized image data.

If the next page button 506 is pressed in a state where the preview images of the first and eighth pages are displayed on the preview image-displaying sections 504 and 505, respectively, the MFP 10 reads out the preview images of the second and seventh pages from the page memory. Then, the MFP 10 displays the preview images of the second and seventh pages on the preview image-displaying sections 504 and 505, respectively, and at the same time, generates preview images of the third and sixth pages and stores the generated images in the page memory as rasterized image data.

By operating as described above, it is possible to increase the speed of preview display. Note that there is a possibility that the preceding page button 503 is pressed in a state where the preview images of the second and seventh pages are displayed, and hence the preview images of the first and eighth pages may be preserved in a state in which data thereof is stored as the rasterized image data in the page memory.

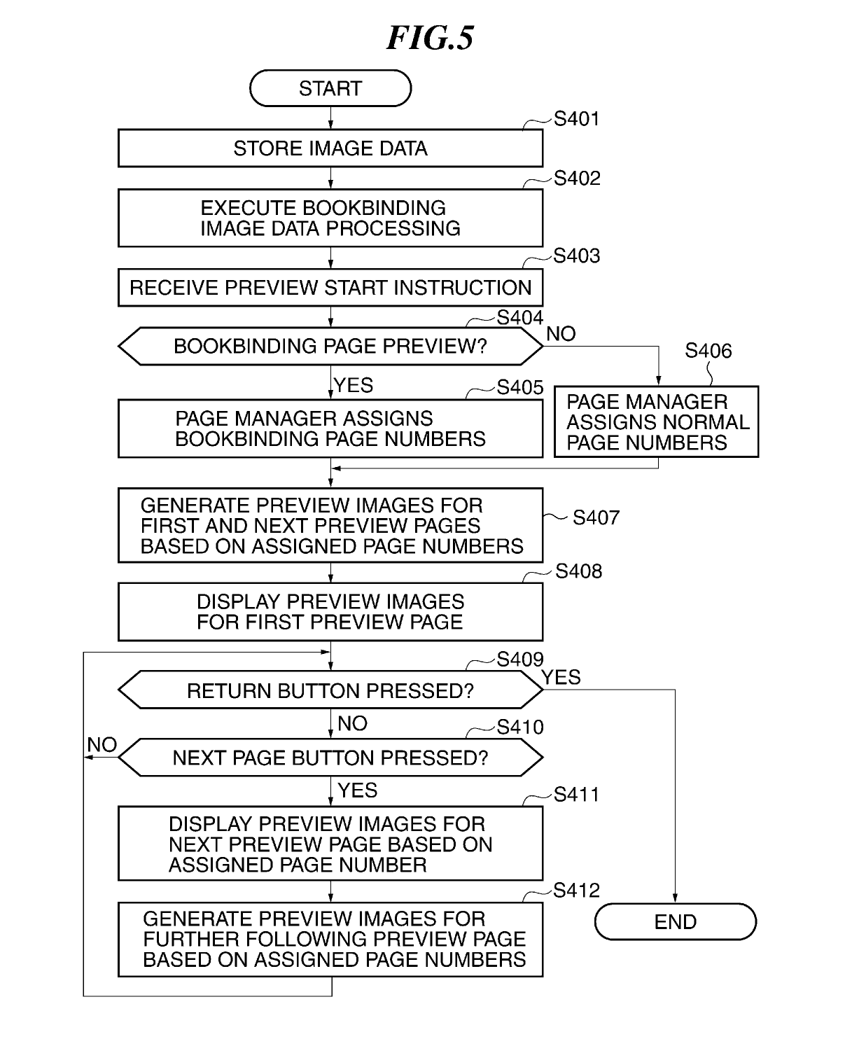

Next, a preview image display process executed by the MFP 10 will be described with reference to FIG. 5.

FIG. 5 is a flowchart of the preview image display process executed by the MFP 10. The present process is realized by the software modules shown in FIG. 3 through control executed mainly by the CPU 205.

First, in a step S401, image data is stored in the HDD 208. Although the image data stored in this step is assumed to be bitmap data obtained by analyzing PDL data received from the PC 20 by the PDL analyzer 304 and converting the PDL data by the data rasterizer 311, the image data may also be PDL data which has not been analyzed or image data input from the scanner section 201.

In a step S402, bookbinding image data processing is executed. More specifically, the panel input/output controller 308 sends information of the bookbinding settings received from the user via the console section 201 to the bookbinding image data generator 312. Then, the bookbinding image data generator 312 performs bookbinding image data processing on the image data stored in the HDD 208 based on the received bookbinding setting information. By execution of bookbinding image data processing, the image data subjected to bookbinding layout (i.e. bookbinding image data) is generated and is stored in the HDD 208. In the step S402, the bookbinding image data generator 312 functions as a bookbinding image data generation unit.

Next, when the panel input/output controller 308 receives a preview start instruction from the user (step S403), the CPU 205 determines whether to display the bookbinding page preview or the normal page preview (step S404). If the bookbinding page preview screen is selected by the preview switch button 502, the CPU 205 proceeds to a step S405, whereas if the normal page preview screen is selected, the CPU 205 proceeds to a step S406.

In the step S405, the page manager 307 assigns page numbers for bookbinding page preview (hereinafter also referred to as “bookbinding page numbers”) to respective pages of the image data which has been subjected to the bookbinding image data processing in the step S402. The bookbinding page numbers refer to page numbers in the physical page order of respective pages of the image data which has been subjected to bookbinding layout (laid out for bookbinding).

In the step S406, the page manager 307 assigns page numbers for normal page preview (hereinafter also referred to as “normal page numbers”) to respective pages of the image data. The normal page numbers do not refer to page numbers in the physical page order of respective pages of the image data which has been subjected to bookbinding layout, but to page numbers in a page order of respective pages of a bookbound booklet.

In a step S407, the preview image generator 305 generates preview images of the first page and the next page based on the page numbers assigned by the page manager 307 in the step S405 or S406, and stores the generated preview images in the page memory. For example, in a case where image data of eight pages is set to bookbinding printing with the settings of double-sided printing, saddle-stitching, and folding in two, the preview images of the first and eighth pages are generated for a first preview page, and the preview images of the second and seventh pages are generated for a next preview page.

In a step S408, the panel input/output controller 308 displays the preview images for the first preview page stored in the page memory on the preview image-displaying sections 504 and 505, respectively. In the above-described example, the screen shown in FIG. 4 is displayed.

In a step S409, if the panel input/output controller 308 determines that the return button 510 has been pressed on the display panel, the CPU 205 terminates the present process. On the other hand, if the panel input/output controller 308 determines that the return button 510 has not been pressed, the CPU 205 proceeds to a step S410. Note that when it is determined that the pressing of the return button 510 has been detected, the image data stored in the HDD 208 and the page memory is deleted.

In the step S410, if the panel input/output controller 308 determines that the next page button 506 has been pressed on the display panel, the CPU 205 proceeds to a step S411. On the other hand, if the panel input/output controller 308 determines that the next page button 506 has not pressed, the CPU 205 returns to the step S409.

In the step S411, the panel input/output controller 308 displays the preview images for the next preview page stored in the page memory on the display panel based on the page numbers assigned by the page manager 307. In the above-described example, the preview images of the second and seventh pages are displayed on the preview image-displaying sections 504 and 505, respectively.

In a step S412, based on the page numbers assigned by the page manager 307 in the step S405 or S406, the preview image generator 305 generates preview images for further following pages (e.g. the preview images of the sixth and third pages). The preview image generator 305 stores the generated preview images in the page memory. Then, the steps S409 to S412 are repeated until the return button 510 is pressed.

In the above-described process, in a case where the image data is PDL data, the image data is converted to an intermediate code by the PDL analyzer 304, and is rasterized into bitmap data by the data rasterizer 311. Then, the preview image generator 305 generates preview images based on the bitmap data, and stores the generated preview images in the page memory.

Although in the above-described process, whether or not the next page button 506 has been pressed is determined in the step S410, whether or not the preceding page button 503 has been pressed may also be determined for preview pages following the first preview page. In this case, if the answer to this question is affirmative (YES), the preview images for the preceding preview page stored in the page memory is displayed.

According to the first embodiment, the page manager 307 assigns page numbers for bookbinding page preview to respective pages of image data which has been subjected to bookbinding image data processing. Then, the preview image generator 305 generates preview images for the first preview page and the next preview page, and stores the generated preview images in the page memory based on the page numbers assigned by the page manager 307. Then, the preview image generator 305 sequentially generates preview images for a preview page following the current preview page being displayed. This makes it possible to improve the user-friendliness by reducing time required to display the preview images, even when image data with the setting of bookbinding printing is to be displayed for preview in the order of physical pages, i.e. in the actual printing order.

Next, a description will be given of a second embodiment of the present invention. The second embodiment has the same hardware and software configurations as those of the first embodiment described hereinabove with reference to FIGS. 1 to 4. Therefore, component elements identical to corresponding ones of the first embodiment are denoted by the same reference numerals, and description thereof is omitted. The following description will be given mainly of different points from the first embodiment.

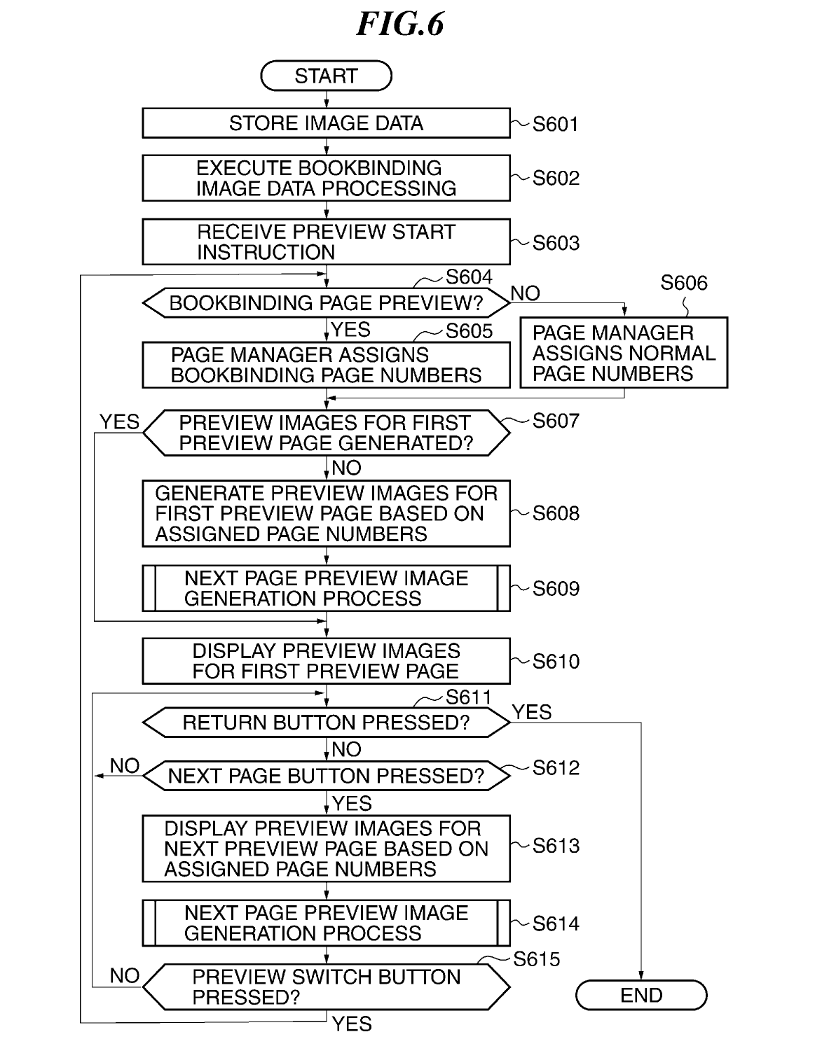

In the second embodiment, a preview image display process executed when the preview switch button 502 is pressed in a state where one of the bookbinding page preview image and the normal page preview image is displayed will be described with reference to FIG. 6.

FIG. 6 is a flowchart of the preview image display process according to the second embodiment. The present process is realized by the software modules shown in FIG. 3 through control executed mainly by the CPU 205. Note that steps S601 to S606 are the same as the steps S401 to S406 in FIG. 5, and hence description thereof is omitted

In a step S607, the CPU 205 determines whether or not the preview image generator 305 have generated the preview images for the first preview page. In this step, the determination is made according to whether or not the preview images for the first preview page have been stored in the page memory. If it is determined that the preview images for the first preview page have been generated, the CPU 205 proceeds to a step S610. On the other hand, if it is determined that the preview images for the first preview page have not been generated, the CPU 205 proceeds to a step S608.

In the step S608, the preview image generator 305 generates the preview images for the first preview page based on the page numbers assigned by the page manager 307 in the step S605 or s606.

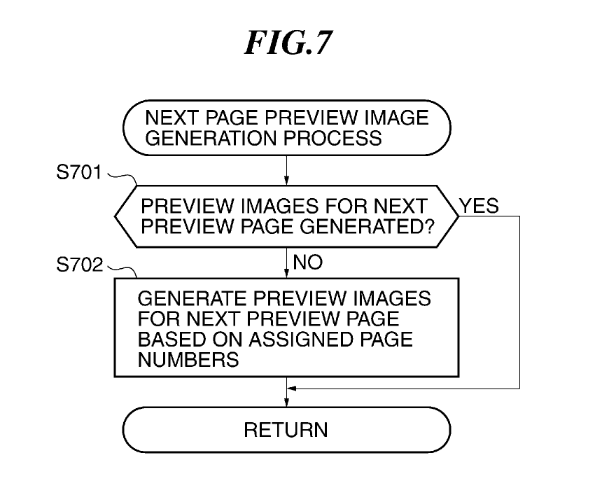

Next, in a step S609, the preview image generator 305 executes a process for generating the preview images for the next preview page based on the page numbers assigned by the page manager 307 in the step S605 or S606. The step S609 will be described in detail hereinafter with reference to FIG. 7.

In the step S610, the panel input/output controller 308 displays the preview images for the first preview page stored in the page memory on the preview image-displaying sections 504 and 505, respectively.

In a step S611, if the panel input/output controller 308 determines that the return button 510 has been pressed on the display panel, the CPU 205 terminates the present process. On the other hand, if the panel input/output controller 308 determines that the return button 510 has not been pressed on the display panel, the CPU 205 proceeds to a step S612.

In the step S612, if the panel input/output controller 308 determines that the next page button 506 has been pressed on the display panel, the CPU 205 proceeds to a step S613. On the other hand, if the panel input/output controller 308 determines that the next page button 506 has not been pressed, the CPU 205 returns to the step S611.

In the step S613, the panel input/output controller 308 displays the preview images for the next preview page stored in the page memory based on the page numbers assigned by the page manager 307.

In a step S614, the preview image generator 305 executes the process for generating the preview images for the next preview page based on the page numbers assigned by the page manager 307 in the step S605 or S606. The step S614 will be described in detail hereinafter with reference to FIG. 7.

In a step S615, if the panel input/output controller 308 determines that the preview switch button 502 has been pressed on the display panel, the CPU 205 returns to the step S604. On the other hand, if the panel input/output controller 308 determines that the preview switch button 502 has not been pressed, the CPU 205 returns to the step S611.

FIG. 7 is a flowchart of the next page preview image generation process, executed in the steps S609 and S614 in FIG. 6.

Referring to FIG. 7, in a step S701, the CPU 205 determines whether or not the preview image generator 305 has generated the preview images for the next preview page. In this step, the determination is made according to whether or not the preview images for the next preview page have been stored in the page memory. If it is determined that the preview images for the next preview page have been generated, the CPU 205 returns, and proceeds to the step S610 or S615 in FIG. 6. On the other hand, if it is determined that the preview images for the next preview page have not been generated, the CPU 205 proceeds to a step S702.

In the step S702, the preview image generator 305 generates preview images for the next page numbers based on the page numbers assigned by the page manager 307 in the step S605 or S606, and stores the generated preview images in the page memory. Then, the preview image generator 305 returns.

According to the second embodiment, when the preview switch button 502 is pressed in a state where one of the bookbinding page preview image and the normal page preview image is displayed, the step S604 and subsequent steps are executed. As a consequence, the page numbers for the preview are assigned to respective pages of the image data by the page manager 307 again, and the preview images for the first preview page and the preview images for the next preview page are generated based on the assigned page numbers. As a result, even when the bookbinding page preview screen and the normal page preview screen are switched therebetween, it is possible to improve the user-friendliness by reducing time required to display the preview images.

Next, a description will be given of a third embodiment of the present invention. The third embodiment has the same hardware and software configurations as those of the first embodiment described hereinabove with reference to FIGS. 1 to 4. Therefore, component elements identical to corresponding ones of the first embodiment are denoted by the same reference numerals, and description thereof is omitted. The following description will be given mainly of different points from the first embodiment.

The MFP 10 as the image processing apparatus according to the third embodiment executes a preview image display process in a case where image data is page-dependent PDL data. The page-dependent PDL data is not randomly accessible on a page-by-page basis, but requires to be interpreted sequentially starting from the first page.

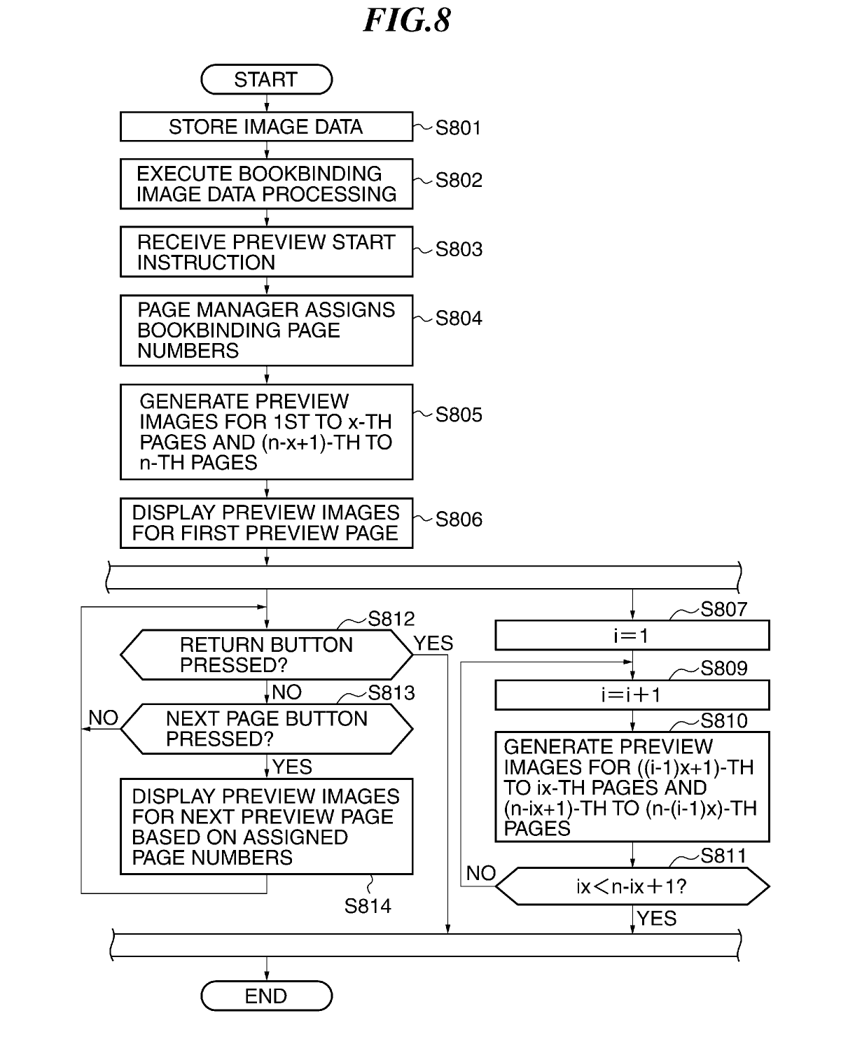

FIG. 8 is a flowchart of the preview image display process in the third embodiment. The present process is realized by the software modules shown in FIG. 3 through control executed mainly by the CPU 205.

First, in a step S801, image data is stored in the HDD 208. The stored image data is page-dependent PDL data.

In a step S802, bookbinding image data processing is executed. More specifically, the panel input/output controller 308 sends information of the bookbinding settings received from the user via the console section 210 to the bookbinding image data generator 312. Then, the bookbinding image data generator 312 performs bookbinding image data processing on the image data stored in the HDD 208 based on the bookbinding setting information. By execution of the bookbinding image data processing, image data subjected to bookbinding layout is generated and is stored in the HDD 208. In the step S802, the bookbinding image data generator 312 functions as the bookbinding image data generation unit.

Next, in a step S803, the panel input/output controller 308 receives a preview start instruction from the user. In a step S804, the page manager 307 assigns the page numbers for the bookbinding page preview (hereinafter also referred to as the “bookbinding page numbers”) to respective pages of the image data which has been subjected to bookbinding image data processing in the step S802. The bookbinding page numbers refer to page numbers in the physical page order of respective pages of the image data which has been subjected to bookbinding layout.

In a step S805, the preview image generator 305 generates preview images based on the image data. More specifically, assuming that the image data is data of n pages, since the image data is page-dependent PDL data, the preview image generator 305 sequentially reads the page images starting from the first page of the image data, and analyzes the first to x-th pages, and the n−x−1-th page to n-th page to thereby generate the preview images. Pages other than the above-mentioned pages are skipped. Note that x represents a given integer defined as 1<x<n, and is set based on the number of pages of preview images which can be displayed on the preview image display sections 504 and 505. The generated preview images are stored in the page memory.

Next, in a step S806, the panel input/output controller 308 displays the preview images for the first preview page stored in the page memory on the preview image display sections 504 and 505, respectively.

Steps S807, S809, S810, and S811 are a process for generating preview images to be displayed next. The processing in these steps and the preview image display processing in steps S812 to S814 are executed simultaneously in parallel.

In the step S807, the preview image generator 305 initializes a counter i for controlling the number of loops to thereby set the counter i to 1. Next, in the step S809, the preview image generator 305 increments the counter i by 1.

In the step S810, similarly to the step S805, the preview image generator 305 sequentially reads the page images starting from the first page of the image data, and generates the preview images of the ((i−1)x+1)-th to ix-th pages and the (n−ix+1)-th to (n−(i−1)x)-th pages. Pages other than the above-mentioned pages are to be skipped.

In the step S811, the preview image generator 305 determines whether or not ix<n−ix+1 is satisfied. If it is determined in the step S811 that ix<n−ix+1 is satisfied, the preview image generator 305 returns to the step S809, whereas if not, the present process is terminated.

Next, the preview image display processing in the steps S812 to S814 will be described.

In the step S812, if the panel input/output controller 308 determines that the return button 510 has been pressed on the display panel, the CPU 205 terminates the present process. On the other hand, if the panel input/output controller 308 determines that the return button 510 has not been pressed, the CPU 205 proceeds to the step S813.

Next, in the step S813, if the panel input/output controller 308 determines that the next page button 506 has been pressed on the display panel, the CPU 205 proceeds to the step S814. On the other hand, if the panel input/output controller 308 determines that the next page button 506 has not been pressed, the CPU 205 returns to the step S812.

In the step S814, the panel input/output controller 308 displays the preview images for the next preview page stored in the page memory on the display panel based on the page numbers assigned by the page manager 307.

According to the third embodiment described above, when the image data is the page-dependent PDL data, the preview images are generated based on a given number of successive page images. This reduces the number of times of page skip processing in generating the preview images, and hence it is possible to prevent the page changing speed from being lowered than in the conventional technique while maintaining an advantageous point of displaying a first preview page at high speed.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-265172, filed Dec. 4, 2012, which is hereby incorporated by reference herein in its entirety.

What is claimed is:

1. An image processing apparatus comprising:
a bookbinding image data generation unit configured to generate bookbinding image data by executing bookbinding layout processing on input image data;
a management unit configured to assign page numbers to respective pages of the bookbinding image data generated by said bookbinding image data generation unit;
a preview image generation unit configured to generate a preview image of the bookbinding image data based on the page numbers assigned by said management unit; and
a display unit configured to display the preview image of the bookbinding image data,
wherein said preview image generation unit generates a preview image of at least a page next to a page of which the preview image is being displayed, based on the page numbers assigned by said management unit during display of the preview image on said display unit.

2. The image processing apparatus according to claim 1, further comprising a display switching unit configured to switch a display method between a first display method for displaying preview images in an order of physical pages, and a second display method for displaying preview images in an order of normal page numbers.

3. The image processing apparatus according to claim 1, wherein when the image data is page-dependent PDL data, said preview image generation unit generates preview images based on a given number of successive page images.

4. A method of displaying a preview image by an image processing apparatus including a display unit that displays an image, comprising:
generating bookbinding image data by executing bookbinding layout processing on input image data;
assigning page numbers to respective pages of the generated bookbinding image data;
generating a preview image of the bookbinding image data based on the assigned page numbers; and
displaying the preview image of the bookbinding image data on the display unit,
wherein said generating of the preview image of bookbinding image data includes generating a preview image of at least a page next to a page of which the preview image is being displayed, based on the assigned page numbers during display of the preview image on the display unit.

5. A non-transitory computer-readable storage medium storing a computer-executable program for causing a computer to execute a method of displaying a preview image by an image processing apparatus including a display unit that displays an image,
wherein the method comprises:
generating bookbinding image data by executing bookbinding layout processing on input image data;
assigning page numbers to respective pages of the generated bookbinding image data;
generating a preview image of the bookbinding image data based on the assigned page numbers; and
displaying the preview image of the bookbinding image data on the display unit,
wherein said generating of the preview image of bookbinding image data includes generating a preview image of at least a page next to a page of which the preview image is being displayed, based on the assigned page numbers during display of the preview image on the display unit.
